(19) United States
(12) Patent Application Publication
(10) Pub. No.: US 2016/0151748 A1
(43) Pub. Date: Jun. 2, 2016

(54) REVERSE OSMOSIS OR NANOFILTRATION MEMBRANES AND METHOD FOR PRODUCTION THEREOF

(71) Applicant: LEIBNIZ-INSTITUT FUER POLYMERFORSCHUNG DRESDEN E.V, Dresden (DE)

(72) Inventors: Jochcen MEIER-HAACK, Dresden (DE); Christian LANGNER, Dresden (DE); Brigitte VOIT, Dresden (DE); Mona ABDEL REHIM, Cairo-Egypt (EG); Daria NIKOLAEVA, Leuven (BE)

(73) Assignee: LEIBNIZ-INSTITUT FUER POLYMERFORSCHUNG DRESDEN E.V ., Dresden (DE)

(21) Appl. No.: 14/952,193

(22) Filed: Nov. 25, 2015

(30) Foreign Application Priority Data
Nov. 29, 2014 (DE) 102014224473.0

(51) Int. Cl. B01D 71/56; B01D 67/00; B01D 71/68; B01D 61/02; B01D 69/12

(52) U.S. Cl. CPC B01D 71/56; B01D 61/025; B01D 61/027; B01D 69/125; B01D 71/68; B01D 67/0006; B01D 2323/26; B01D 2323/40

(57) ABSTRACT

Reverse osmosis or nanofiltration membranes having a substrate on which a porous supporting layer is arranged, on which supporting layer a separation-active layer is arranged, on which separation-active layer a cover layer is arranged, wherein the separation-active layer comprises polyamide with acid chloride groups on the surface of the separation-active layer, and wherein the cover layer comprises a polymer containing functional groups, and the functional groups of the cover layer are coupled in a chemically reactive manner with the acid chloride groups of the polyamide of the separation-active layer. Embodiments are also directed to a method in which at least one cover layer is applied to the separation-active layer of polyamide immediately thereafter.

### CROSS-REFERENCE TO RELATED APPLICATIONS

The present application claims priority under 35 U.S.C. §119 of German Patent Application No. 102014224473.0, filed Nov. 29, 2014, the disclosure of which is expressly incorporated by reference herein in its entirety.

### BACKGROUND OF THE DISCLOSURE

1. Field of the Disclosure

The disclosure concerns the field of polymer chemistry and relates to reverse osmosis or nanofiltration membranes, as they are, for example, used to treat service water, for seawater desalinization, for removing persistent organic pollutants (POP) or for increasing the concentration of juices or musts, and to a method for the production thereof.

2. Discussion of Background Information

Nanofiltration is a pressure-driven membrane technique that traps dissolved molecules, heavy metal ions and other small particles. Membranes that are used in nanofiltration have, by definition, a pore size of at most 2 nm, which differentiates them from coarser membranes that are used in ultrafiltration and microfiltration. To fully separate all dissolved substances from the solvent, however, the next finer technique, reverse osmosis, is necessary. Compared to reverse osmosis, filters that are correspondingly coarser, as well as lower working pressures, are used in nanofiltration. However, the membranes used for filtration are normally only thermally stable or chemically resistant to a limited extent, as a result of which, application of the method is essentially confined to water treatment.

Reverse osmosis is a physical method for increasing the concentration of materials dissolved in liquids, during which increase, the natural osmosis process is reversed using pressure. The medium in which the concentration of a particular substance is to be reduced is separated from the medium in which the concentration is to be increased by a semi-permeable membrane. The latter medium is exposed to a pressure that must be higher than the pressure that is produced by the osmotic tendency to equalize concentrations. Thus, the molecules of the solvent can move against their “natural” osmotic dispersion direction. The method forces the molecules into the compartment in which the dissolved substances are present at a lower concentration.

Drinking water has an osmotic pressure of less than 0.2 MPa; the pressure applied for the reverse osmosis of drinking water is 0.3 to 3 MPa, depending on the membrane used and on the system configuration. For seawater desalinization, a pressure of 6 to 8 MPa is required, since seawater has, at approximately 3 MPa, a significantly higher osmotic pressure than drinking water. In some applications, for example, for increasing the concentration of landfill leachate, even higher pressures are used.

A reverse osmosis membrane that allows only the carrier liquid (solvent) to pass through and retains the dissolved substances (solute) must be able to withstand these high pressures. If the pressure difference more than offsets the osmotic gradient, the solvent molecules pass through the membrane as in the case of a filter, while the “impurity molecules” are retained. Unlike a classic membrane filter, osmosis membranes do not have continuous pores. Instead, the ions and molecules move through the membrane by diffusing through the membrane material. The solution/diffusion model describes this process.

Various solutions for this type of reverse osmosis or nanofiltration membranes are known, as are various production methods.

Asymmetrical composite membranes represent one solution. These membranes are composed of a porous substrate, typically a fleece; a porous support layer, preferably of polysulfone or polyethersulfone, applied thereto; and a separation-active layer applied thereto composed of a crosslinked aromatic or partially aromatic polyamide. Membranes of this type exhibit high salt rejection (>99%) and relatively high permeabilities (3.5 L/m² h MPa). Disadvantages of these membranes are their high fouling tendency and high sensitivity to free chlorine species such as Cl₂, HOCl or OCl—,

Fouling is generally understood as a decrease in the permeability of a membrane as a result of deposits of organic or inorganic water-borne substances during operation, and can be reversible or irreversible. Irreversible organic fouling (irreversible bonding of organic water-borne substances to the polyamide layer) is promoted by hydrophobic interactions and π-π interactions between the membrane surface and the water-borne substances.

In addition to the pre-purification of the feed stream, structural design of the systems, operating conditions and purification methods, the chemical and physical properties of the membrane surfaces represent a major aspect for reducing the fouling.

Pre-purifying the feed stream often also involves a disinfection stage in which chlorine-containing agents, such as free chlorine or hypochlorite, are used. It is known that polyamide breaks down quickly under the influence of free chlorine. Despite a deactivation of the free chlorine species prior to contact with the reverse osmosis or nanofiltration membranes, there is a risk of membrane damage in each purification cycle.

A change in the chemical and physical properties of the membrane surface to reduce fouling can be achieved by altering the chemical composition of the polyamide layer or by a surface modification using hydrophilic polymers. The materials used for the modification should themselves be as inert as possible in relation to free chlorine species and/or reduce the convection thereof to the polyamide layer.

According to S. Yu et al.: J. Membr. Sci. 379 (2011) 164 and M. Liu et al.: Desalination 288 (2012) 98, thin-layer membranes are known which are produced by interfacial polymerization and in which a polyvinyl amine was used as the amine component.

According to Y.-C. Chiang et al.: J. Membr. Sci. 326 (2009) 19-26 and C. Wu et al.: J. Membr. Sci. 472 (2014) 141-153, thin-layer membranes with a coating of highly branched polyethyleneimine are known which are also produced by interfacial polymerization.

According to EP 0780152 B1, a semi-permeable composite membrane and a method for the production thereof are known, which membrane is composed of a microporous substrate that is provided with a semi-permeable microporous substrate membrane, such as a polysulfone membrane, which comprises on at least one side a water-permeable polymeric layer that contains the interfacial polymerization product of an aliphatic amine-terminated dendrimer, such as a propylamine, and a compound polymerizing therewith, such as a toluene diisocyanate, or a carboxylic acid chloride or a sulfonic acid chloride. The composite membrane is produced by interfacial polymerization reactions between an aliphatic amine-terminated dendrimer and a compound that can be polymerized therewith.

The incorporation of a dendritic poly(amide amine) (PAMAM) by polymerization into the separation-active layer of a thin-layer membrane is also known (L. Li et al.: J. Membr. Sci. 269 (2006) 84).

As is known, the acid chloride groups remain at least on the surface of the polyamide layer during interfacial polymerization. According to Kang, et al.: Polymer 48 (2007) 1165, the modification of the polyamide surface via chemical bonding of an amine-terminated polyethylene glycol monomethyl ether by a chemical reaction of the amine groups with the acid chloride groups is known. For this purpose, the acid chloride solution is removed after the interfacial polymerization, and the membrane is covered with an aqueous solution of the amine-terminated polyethylene glycol monomethyl ether. The anti-fouling effect was demonstrated in filtration experiments with a dodecyltrimethylammonium bromide solution and an aqueous tannin solution. However, no values were stated for permeate flow and salt rejection.

According to Zou et al.: Sep. Pur. Technol. 72 (2010) 256, the acid chloride groups located on the surface of the polyamide layer are caused to react with m-phenylenediamine. For this purpose, the acid chloride solution is removed after the interfacial polymerization, and the surface is brought into contact with an aqueous solution of the diamine. In a further step, the membrane surface is again brought into contact with an acid chloride solution after the diamine solution is removed. The acid chloride groups produced on the surface in this process step are covered by an aqueous diamine solution after the removal of the acid chloride solution. A “multi-layer membrane” of this type showed, in comparison with a “single-layer membrane,” slightly improved permeate flow and slightly increased salt rejection. Filtration experiments with a dodecyltrimethylammonium bromide solution and an aqueous humic acid solution show a reduced fouling tendency of the “multi-layer membrane” as compared to the “single-layer membrane.”

From U.S. Pat. No. 6,177,011 B1, a reverse osmosis or nanofiltration membrane comprising a substrate with a layer of polyamide and a separation layer of polyvinyl alcohol subsequently applied thereto is known, which membrane exhibits a high salt-rejection capacity, high water permeability and high fouling resistance.

According to I.-C. Kim et al.: J. Ind. Eng. Chem. 10 (2004) 115, nanofiltration and reverse osmosis membranes are known that were subsequently modified with polyvinyl alcohol. For fixation, the polyvinyl alcohol was crosslinked with glutaraldehyde. The modification resulted in a reduction in permeability and an increase in salt rejection for the nanofiltration membrane, whereas the reverse effect was observed for the reverse osmosis membrane.

In membrane technology, fouling is understood as meaning the contamination of filter membranes. In ultrafiltration and microfiltration, the filtration process is influenced to a very high degree by filter cake formation (cover layer formation). The filtration effect is significantly impaired by this filter cake formation.

In all known solutions, it is disadvantageous that the respective fouling properties, alone or in combination with a desired water permeability, are still insufficient.

### SUMMARY OF EMBODIMENTS OF THE DISCLOSURE

The aim of the present disclosure is the specification of reverse osmosis or nanofiltration membranes that exhibit good to very good fouling properties with a good to very good rejection capacity for dissolved substances, and in particular for salts, and in the specification of a simple and cost-effective method for the production thereof.

The aim is attained by the disclosure disclosed in the claims. Advantageous embodiments are the subject matter of the dependent claims.

The reverse osmosis or nanofiltration membranes according to the disclosure comprise at least one substrate on which a porous supporting layer is arranged, on which supporting layer at least one separation-active layer is arranged, and on which separation-active layer at least one cover layer is also arranged, wherein the separation-active layer comprises polyamide applied by interfacial polymerization and has acid chloride groups on at least the surface of the separation-active layer, and wherein the cover layer comprises at least one polymer containing functional groups, and the functional groups of the cover layer are coupled in a chemically reactive manner with the acid chloride groups of the polyamide of the separation-active layer.

Advantageously, the substrate is a textile fabric, more advantageously a fleece.

Likewise advantageously, the porous supporting layer comprises polysulfone or polyethersulfone.

Further advantageously, the cover layer comprises at least one polymer containing functional groups, which polymer is water soluble and/or alcohol soluble and/or soluble in a water/alcohol mix.

And also advantageously, the cover layer comprises at least one highly branched polymer containing functional groups.

It is also advantageous if the cover layer comprises polyethyleneimine and/or polypropyleneimine and/or poly(amide amine) and/or polyamine and/or polyetherol and/or polyol and/or polysaccharide and/or chitosan.

And it is also advantageous if the polymers of the cover layer comprise primary and/or secondary amino groups or hydroxyl groups as functional groups.

In the method for producing reverse osmosis or nanofiltration membranes according to the disclosure, at least one porous supporting layer is applied to a substrate, to which supporting layer at least one separation-active layer of polyamide is then applied by interfacial polymerization, and to which separation-active layer at least one cover layer of at least one polymer containing functional groups is also applied immediately thereafter.

Advantageously, the cover layer is applied to the separation-active layer in the form of an aqueous solution and/or an alcoholic solution and/or a solution in a water/alcohol mix using a spraying method or a drawdown method or a dipping method, more advantageously using a spraying method, immediately after the interfacial polymerization of the separation-active layer.

Likewise advantageously, the cover layer is applied as an aqueous solution.

Further advantageously, the polymers containing functional groups are used in the aqueous solution and/or the alcoholic solution and/or the solution in a water/alcohol mix at a concentration between 5 and 30 mass %, preferably between 10 and 20 mass %.

With the solution according to the disclosure, it is possible for the first time to specify reverse osmosis or nanofiltration membranes that exhibit good to very good fouling properties with a good to very good rejection capacity for dissolved substances and in particular for salts. According to the disclosure, these membranes can be produced using a simple and cost-effective method.

This is achieved by reverse osmosis or nanofiltration membranes which comprise at least one substrate. This substrate is a textile fabric, advantageously a fleece, for example. At least one porous supporting layer is applied to this substrate. Advantageously, this substrate comprises polysulfone or polyethersulfone. At least one separation-active layer of polyamide applied by interfacial polymerization and having acid chloride groups, which are at least arranged on the surface of the separation-active layer, is in turn present on the supporting layer. Finally, there is at least one cover layer on the separation-active layer, wherein the cover layer comprises at least one polymer containing functional groups. Advantageously, all layers are arranged on top of one another over their entire surfaces.

It is essential to the embodiments of the disclosure that the functional groups of the cover layer are thereby coupled with the acid chloride groups of the polyamide of the separation-active layer in a chemically reactive manner. In order to be able to achieve this reactive coupling with the acid chloride groups of the polyamide, the groups must still be available as the coupling partner. It is therefore essential to the embodiments of the disclosure that, after the application of at least one porous supporting layer to the substrate and the subsequent application of at least one separation-active layer of polyamide to the supporting layer by interfacial polymerization, the cover layer is applied to the separation-active layer immediately after the application of the separation-active layer.

The polymers of the cover layer that contain functional groups are advantageously water soluble and/or alcohol soluble and/or soluble in a water/alcohol mix, and can thus be applied to the separation-active layer in the form of an aqueous solution and/or an alcoholic solution and/or a solution in a water/alcohol mix by interfacial polymerization immediately following the application of the separation-active layer.

Advantageously, the cover layer is applied as an aqueous solution of the polymers with functional groups.

In the case of a solution of the polymers with functional groups, the polymers are present in the solvent at a concentration between 5 and 30 mass %, advantageously between 10 and 20 mass %.

The cover layer is then advantageously applied by a spraying method or a dipping method or a drawdown method. It is more advantageous if the cover layer is applied by spraying, since the separation-active layer is at this point mechanically very unstable and damage to or particularly a removal of the separation-active layer must be avoided.

Advantageously, highly branched polymers containing functional groups, but also for example polyethyleneimine and/or polypropyleneimine and/or poly(amide amine) and/or polyamine and/or polyetherol and/or polyol and/or polysaccharide and/or chitosan, can be present as polymers for the cover layer.

The polymers of the cover layer advantageously comprise primary and/or secondary amino groups or hydroxyl groups as functional groups. However, spacer groups can also be arranged between the acid chloride groups and the functional groups of the polymers of the cover layer, so that a direct covalent coupling of the separation-active layer with the cover layer via chemical reactions does not necessarily need to be present; rather, an indirect covalent coupling can also be present. A greater number of options is thus available for coupling polymers with functional groups.

With the solution according to the disclosure, reverse osmosis or nanofiltration membranes are provided which exhibit a low fouling tendency and a high resistance to chlorine with no negative influence on their filtration properties, such as permeability and salt rejection. According to the disclosure, this is achieved by coating the separation-active layer with a hydrophilic multifunctional layer of a, preferably highly branched, polymer having functional groups that become reactively coupled with the acid chloride groups present at least on the surface of the separation-active layer of polyamide. The covalent bonding of the groups enables a coupling of the cover layer to the separation-active layer that is stable in the long term. The cover layer according to the disclosure is a hydrophilic multifunctional hydrogel layer, by which the hydrophilicity of the membrane surface is increased and the roughness of the surface is reduced. As a result of this increased hydrophilicity of the membrane surface, a hydrophilicity virtually similar or equal to water is achieved, so that the tendency of fouling by the dissolved substances on the membrane is low and the advantageous properties of the membrane according to the disclosure are thus achieved.

Additional embodiments of the present disclosure are directed to a reverse osmosis or nanofiltration membrane, comprising at least one substrate; at least one porous supporting layer arranged on the at least one substrate; at least one separation-active layer arranged on the at least one supporting layer; and at least one cover layer arranged on the at least one separation-active layer. The at least one separation-active layer comprises of a polyamide applied by interfacial polymerization and has acid chloride groups at least on a surface of the at least one separation-active layer. The at least one cover layer comprises at least one polymer containing functional groups, and the functional groups of the cover layer are coupled in a chemically-reactive manner with the acid chloride groups of the polyamide of the separation-active layer.

In embodiments of the disclosure, the at least one substrate is a textile fabric.

In further embodiments of the disclosure, the textile fabric is a fleece.

In additional embodiments of the disclosure, the at least one porous supporting layer comprises polysulfone or polyethersulfone.

In yet further embodiments of the disclosure, the at least one polymer containing functional groups is water soluble and/or alcohol soluble and/or soluble in a water/alcohol mix.

In embodiments of the disclosure, the at least one cover layer comprises at least one highly branched polymer containing the functional groups.

In further embodiments of the disclosure, the at least one cover layer comprises polyethyleneimine and/or polypropyleneimine and/or poly(amide amine) and/or polyamine and/or polyetherol and/or polyol and/or polysaccharide and/or chitosan.

In additional embodiments of the disclosure, the polymers of the at least one cover layer comprises primary and/or secondary amino groups or hydroxyl groups as the at least one functional group.

Additional aspects of the disclosure are directed to a method for producing a reverse osmosis or nanofiltration membrane comprising a substrate, at least one porous supporting layer applied to the substrate, at least one separation-active layer of polyamide applied to the at least one supporting layer, and at least one cover layer of at least one polymer containing functional groups arranged on the at least one separation-active layer. The method comprises applying the at least one separation-active layer of polyamide to the at least one supporting layer by interfacial polymerization, and applying the at least one cover layer to the at least one separation-active layer immediately after the applying the at least one separation-active layer to the at least one supporting layer.

In embodiments of the disclosure, the applying the at least one cover layer to the at least one separation-active layer comprises applying the at least one cover layer in the form of an aqueous solution and/or an alcoholic solution and/or a solution in a water/alcohol mix using a spraying method or a drawdown method or a dipping method immediately after the interfacial polymerization of the at least one separation-active layer.

In further embodiments of the disclosure, the applying the at least one cover layer to the at least one separation-active layer comprises applying the at least one cover layer in the form of an aqueous solution and/or an alcoholic solution and/or a solution in a water/alcohol mix using a spraying method immediately after the interfacial polymerization of the at least one separation-active layer.

In additional embodiments of the disclosure, the applying the at least one cover layer to the at least one separation-active layer comprises applying the at least one cover layer as an aqueous solution.

In yet further embodiments of the disclosure, the polymers containing functional groups are used in the aqueous solution and/or the alcoholic solution and/or the solution in a water/alcohol mix at a concentration between 5 and 30 mass %.

In embodiments of the disclosure, the polymers containing functional groups are used in the aqueous solution and/or the alcoholic solution and/or the solution in a water/alcohol mix at a concentration between 10 and 20 mass %.

Other exemplary embodiments and advantages of the present disclosure may be ascertained by reviewing the present disclosure.

### BRIEF DESCRIPTION OF THE DRAWINGS

Embodiments of the present disclosure, which are presented for better understanding the inventive concepts and which are not the same as limiting the disclosure, will now be described with reference to the figures in which:

FIG. 1 depicts an exemplary schematic drawing of a reverse osmosis or nanofiltration membrane in accordance with aspects of the disclosure; and

FIG. 2 depicts an exemplary flow diagram for forming reverse osmosis or nanofiltration membrane in accordance with aspects of the disclosure.

### DETAILED DESCRIPTION OF EMBODIMENTS OF THE DISCLOSURE

The particulars shown herein are by way of example and for purposes of illustrative discussion of the embodiments of the present disclosure only and are presented in the cause of providing what is believed to be the most useful and readily understood description of the principles and conceptual aspects of the present disclosure. In this regard, no attempt is made to show structural details of the present disclosure in more detail than is necessary for the fundamental understanding of the present disclosure, the description taken with the drawings making apparent to those skilled in the art how the several forms of the present disclosure may be embodied in practice.

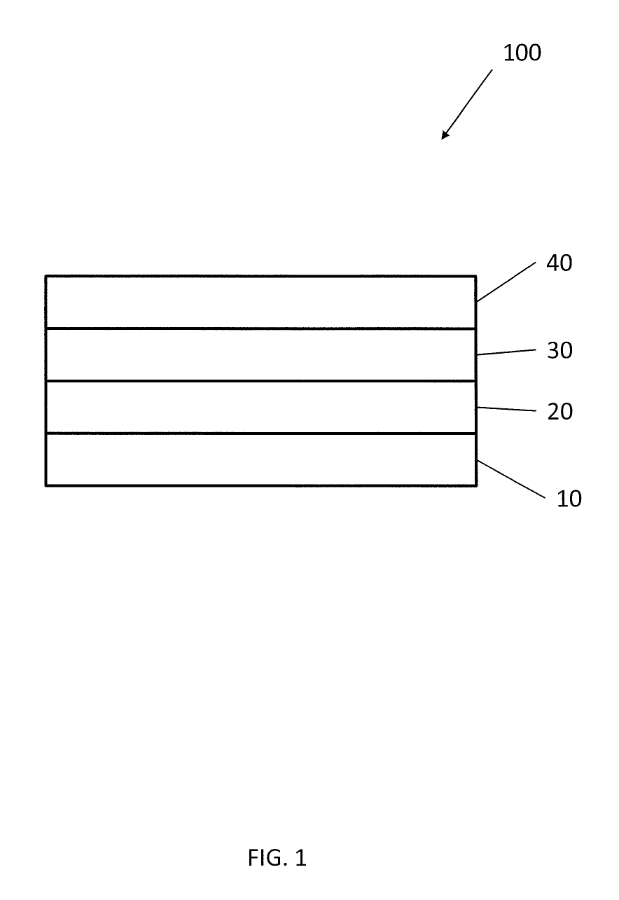

FIG. 1 depicts an exemplary schematic drawing of a reverse osmosis or nanofiltration membrane 100 in accordance with aspects of the disclosure. As shown in FIG. 1, the reverse osmosis or nanofiltration membrane 100 includes at least one substrate 10, at least one porous supporting layer 20 arranged on the at least one substrate 10, at least one separation-active layer 30 arranged on the supporting layer 20, and at least one cover 40 layer arranged on the separation-active layer 30. The separation-active layer 30 comprises a polyamide applied by interfacial polymerization and has acid chloride groups at least on the surface of the separation-active layer 30. The cover layer 40 comprises at least one polymer containing functional groups, and the functional groups of the cover layer 40 are coupled in a chemically-reactive manner with the acid chloride groups of the polyamide of the separation-active layer 30.

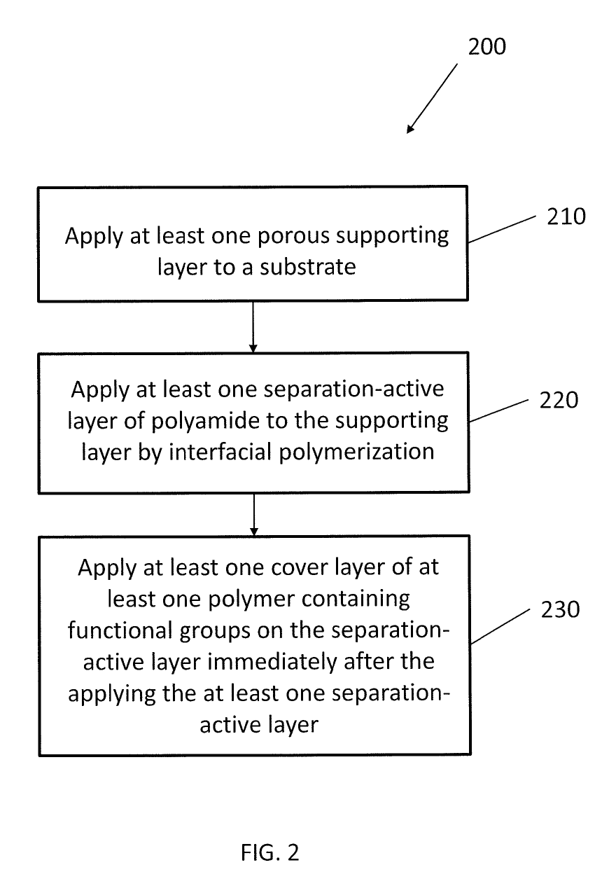

FIG. 2 depicts an exemplary flow 200 for forming reverse osmosis or nanofiltration membrane in accordance with aspects of the disclosure. As shown in FIG. 2, at step 210, at least one porous supporting layer applied to a substrate. At step 220, at least one separation-active layer of polyamide is applied to the supporting layer by interfacial polymerization. At step 230, at least one cover layer of at least one polymer containing functional groups is applied on the separation-active layer immediately after the applying the at least one separation-active layer.

### Example 1

### Comparative Example

A reverse osmosis or nanofiltration membrane is produced from a supporting membrane comprising a fleece and a porous polyethersulfone layer applied thereto having a size of 85.2 cm² in that the supporting membrane is dipped into a solution of m-phenylenediamine in water (concentration: 20 g/L). The excess liquid is removed by a roller. The impregnated supporting membrane is then inserted into a frame, wherein the polyethersulfone surface faces upward and an acid chloride solution of 1 g/L trimesoyl chloride (TMC) in a hexane/tetrahydrofuran (THF) mixture with 0.5% THF is poured onto the polyethersulfone surface. This forms the separation-active layer. After 180 s, the excess acid chloride solution is removed by decanting. The impregnated and coated supporting membrane is then dried at room temperature for 30 s and at 80° C. for 120 s.

The reverse osmosis or nanofiltration membrane produced in this manner is then washed with fully desalinated (FD) water for 2 h, then with 1 mM hydrochloric acid with a pH of 3 for 20 h, and then again with FD water for 2 h in order to remove the residual monomers.

This membrane was installed in a filtration cell, subjected to an aqueous solution of 3.5 g/L sodium chloride at a pressure of 5 MPa and a flow rate of 90 kg/h and left for 16 h. The permeability of the membrane was 7.1 L/m² hMPa and the salt rejection was 98.2%.

### Example 2

A reverse osmosis or nanofiltration membrane is produced from a supporting membrane comprising a fleece and a porous polyethersulfone layer applied thereto having a size of 85.2 cm² in that the supporting membrane is dipped into a solution of m-phenylenediamine in water (concentration: 20 g/L). The excess liquid is removed by a roller. The impregnated supporting membrane is then inserted into a frame, wherein the polyethersulfone layer faces upward and an acid chloride solution of 1 g/L trimesoyl chloride (TMC) in a hexane/tetrahydrofuran (THF) mixture with 0.5% THF is poured onto the surface. This forms the separation-active layer. After 180 s, the excess acid chloride solution is removed by decanting.

Immediately thereafter, a solution of 10 mass % poly(amide amine) (PAMAM) in water is then sprayed onto the surface of the separation-active layer as a cover layer. After an additional 180 s, the membrane is then dried at 80° C. for 120 s.

The reverse osmosis or nanofiltration membrane produced in this manner is then washed with 1 mM hydrochloric acid with a pH of 3 for 20 hours and then with FD water for 2 hours in order to remove the residual monomers.

This membrane was installed in a filtration cell, subjected to an aqueous solution of 3.5 g/L sodium chloride at a pressure of 5 MPa and a flow rate of 90 kg/h and left for 16 h. The permeability of the membrane was 8.5 L/m² hMPa and the salt rejection was 98.2%.

To test the fouling tendency of the membranes, the water flow was exposed to a protein solution with 1 g/L bovine serum albumin (BSA) at a pH of 7 before and after filtration. Compared to the membrane according to Example 1 (comparative example without a cover layer), the membrane with the cover layer from Example 2 showed a significantly decreased fouling tendency. The decrease in permeate flow over time during the protein filtration of the membrane modified with a cover layer from Example 2 is 75% lower than that of the unmodified membrane from Example 1.

The testing of the chlorine resistance of the membranes from Example 1 and Example 2 was conducted by a filtration with a calcium hypochlorite solution (500 ppm hypochlorite) at a pH of 7 and a pressure of 5 MPa. The useful life of the membrane modified with a cover layer was increased by a factor of 2 (two) from 1250 ppm/h to 2500 ppm/h.

It is noted that the foregoing examples have been provided merely for the purpose of explanation and are in no way to be construed as limiting of the present disclosure. While the present disclosure has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present disclosure in its aspects. Although the present disclosure has been described herein with reference to particular means, materials and embodiments, the present disclosure is not intended to be limited to the particulars disclosed herein; rather, the present disclosure extends to all functionally equivalent structures, methods and uses, such as are within the scope of the appended claims.

1. A reverse osmosis or nanofiltration membrane, comprising:
at least one substrate;
at least one porous supporting layer arranged on the at least one substrate;
at least one separation-active layer arranged on the at least one supporting layer; and
at least one cover layer arranged on the at least one separation-active layer,
wherein the at least one separation-active layer comprises a polyamide applied by interfacial polymerization and has acid chloride groups at least on a surface of the at least one separation-active layer, and
wherein the at least one cover layer comprises at least one polymer containing functional groups, and the functional groups of the cover layer are coupled in a chemically-reactive manner with the acid chloride groups of the polyamide of the separation-active layer.

2. The reverse osmosis or nanofiltration membrane according to claim 1, wherein the at least one substrate is a textile fabric.

3. The reverse osmosis or nanofiltration membrane according to claim 2, wherein the textile fabric is a fleece.

4. The reverse osmosis or nanofiltration membrane according to claim 1, wherein the at least one porous supporting layer comprises polysulfone or polyethersulfone.

5. The reverse osmosis or nanofiltration membrane according to claim 1, wherein the at least one polymer containing functional groups is water soluble and/or alcohol soluble and/or soluble in a water/alcohol mix.

6. The reverse osmosis or nanofiltration membrane according to claim 1, wherein the at least one cover layer comprises at least one highly branched polymer containing the functional groups.

7. The reverse osmosis or nanofiltration membrane according to claim 1, wherein the at least one cover layer comprises polyethyleneimine and/or polypropyleneimine and/or poly(amide amine imine) and/or polyamine and/or polyetherol and/or polyol and/or polysaccharide and/or chitosan.

8. The reverse osmosis or nanofiltration membrane according to claim 1, wherein the at least one polymer of the cover layer comprises primary and/or secondary amino groups or hydroxyl groups as the at least one functional group.

9. A method for producing a reverse osmosis or nanofiltration membrane comprising a substrate, at least one porous supporting layer applied to the substrate, at least one separation-active layer of polyamide applied to the at least one supporting layer, and at least one cover layer of at least one polymer containing functional groups arranged on the at least one separation-active layer, the method comprising:
applying the at least one separation-active layer of polyamide to the at least one supporting layer by interfacial polymerization, and
applying the at least one cover layer to the at least one separation-active layer immediately after the applying the at least one separation-active layer to the at least one supporting layer.

10. The method according to claim 9, wherein the applying the at least one cover layer to the at least one separation-active layer comprises applying the at least one cover layer in the form of an aqueous solution and/or an alcoholic solution and/or a solution in a water/alcohol mix using a spraying method or a drawdown method or a dipping method immediately after the interfacial polymerization of the at least one separation-active layer.

11. The method according to claim 10, wherein the applying the at least one cover layer to the at least one separation-active layer comprises applying the at least one cover layer in the form of an aqueous solution and/or an alcoholic solution and/or a solution in a water/alcohol mix using a spraying method immediately after the interfacial polymerization of the at least one separation-active layer.

12. The method according to claim 9, wherein the applying the at least one cover layer to the at least one separation-active layer comprises applying the at least one cover layer as an aqueous solution.

13. The method according to claim 10, wherein the polymers containing functional groups are used in the aqueous solution and/or the alcoholic solution and/or the solution in a water/alcohol mix at a concentration between 5 and 30 mass %.

14. The method according to claim 10, wherein the polymers containing functional groups are used in the aqueous solution and/or the alcoholic solution and/or the solution in a water/alcohol mix at a concentration between 10 and 20 mass %.
